(19) United States
(12) Patent Application Publication
(10) Pub. No.: US 2006/0150497 A1
(43) Pub. Date: Jul. 13, 2006

(54) Method of hydroponic cultivation and components for use therewith

(76) Inventor: Craig L. Kaprielian, Reedley, CA (US)

Correspondence Address: LADAS & PARRY LLP, 224 SOUTH MICHIGAN AVENUE, SUITE 1600, CHICAGO, IL, 60604, US

(21) Appl. No.: 11/017,452

(22) Filed: Dec. 20, 2004

(51) Int. Cl. A01G 31/06

(52) U.S. Cl. 47/62 R

(57) ABSTRACT

A method and components for the hydroponic cultivation of plant materials. The components include confined containers, a confined irrigation/fertigation system, field and plant sensors, a plant support system, and an overcovering structure. Each of these components used singularly or in combination with each other enhances the growth and yield of plant material decreases the associated costs of cultivation, and decreases adverse environmental impacts.

### BACKGROUND OF THE INVENTION

1. Field of the Invention

The invention relates generally to a method and components for hydroponic cultivation, and more specifically to a method and components for increasing plant yields while decreasing the associated costs of time, labor growing space, fertilizer, fumigation, water, etc., and also decreasing the associated environmental impact.

2. Description of the Prior Art

The commercial production of plants and plant material for consumption is plagued with many difficulties associated with natural botanical characteristics and the environment in which the plants are grown. Proper horticultural practices to minimize these difficulties and maximize plant growth and production are necessary to ensure commercially viable production.

Commercial farms have evolved to grow plants in organized rows. The rows help facilitate the planting, feeding, trimming, feeding, watering, maintenance and harvesting of the plants or food products grown by the plants. Conventional growing practices often utilize flood-type irrigation techniques and mass spraying of chemicals used to fumigate and fertilize.

Flood irrigation and mass spraying, besides being wasteful of water and chemical resources, has the potential to damage surface soils and both ground water and surface water sources. Irrigating floodwater applied to fields promotes erosion and promotes run-off of fertilizers and pesticides into water sources. In arid environments flood irrigation often leads to soil mineralization associated with the buildup of surface salts. Flood irrigation also creates large swings over time in the amount of moisture in the soil, which stresses the plants.

Agricultural fields, especially those in continuous use, year after year, are usually infested with harmful nematodes that attack the roots of plants that are planted. Development of nematode resistant plant varieties and crop rotation have lessened the problem of nematode infestation to a limited extent. A field is typically fumigated before planting with a substance such as methyl bromide in an effort to kill the nematodes, but this also has achieved limited success since the harmful nematodes reside approximately 12 inches below the surface of the soil. The use of methyl bromide is also being severely restricted or banned completely in some regions due to adverse environmental effects associated with its use. Methyl bromide and other fumigants also kill many of the organisms in the soil that are beneficial to plants.

Furthermore, in traditional flood irrigation a significant percentage of water applied to a field is lost either through evaporation to the air or migration below the effective root zone of the plants. The downward migration of water also has the negative consequence of carrying fertilizers, pesticides and insecticides into the groundwater. This technique wastes water resources, as does more advanced sprinkler techniques, although to a lesser extent.

Thus traditional cultivation methods in soil are very wasteful of resources that are not focused on plant production, and has a harsh impact on the environment.

Hydroponic cultivation has been previously practiced to grow vegetables, flowers and other annual crops that do not develop a large root system. However, the use of hydroponic cultivation for perennial plants that typically develop large root systems, such as trees, vines, bushes and shrubs, has not been used. It was previously thought that the hydroponic cultivation of such plants would require large planting containers for the root systems to develop, which would not be cost effective.

### BRIEF SUMMARY OF THE INVENTION

The present invention utilizes a number of techniques and components to enhance plant production. The method of cultivation utilizes, in various possible combinations depending on the plant material, planting containers, confined irrigation and fertigation, field sensors in the planting containers and on the plants, protective collars, plant supporting structures, and plant overcovering structures to increase plant yields. A further benefit of the use of these components and related methods is the decreased use of space, time to harvest, use of water, use of fertilizers, use of pesticides, labor and loss of plants to inclimate weather. The methods and components also substantially reduce adverse environmental impacts.

### BRIEF DESCRIPTION OF THE DRAWING FIGURES

FIG. 1 is a perspective view of a row of young fruit trees grown in accordance with the present invention;

FIG. 2 is a more detailed view of a single tree being grown in accordance with the present invention;

FIG. 3 is a cross-sectional view of the components shown in FIG. 1, including a cross-sectional view of the container and growing medium; and

FIG. 4 shows a diagram depicting a process for mixing additives into irrigation water.

### DETAILED DESCRIPTION OF THE PREFERRED EMBODIMENTS

As shown in the drawing figures, a component of the present invention is a planting container 10 that provides a confined space for the roots of the plant to develop. The planting medium may be any that is commonly known such as a mixture of 80% Peat Moss and 20% Pearlite potting soil. Openings 12 in the planting container 10 allow for drainage of excess moisture within the containers.

The planting containers 10 may also be isolated from direct contact with the underlying soil. This may be accomplished in several ways such as placing the containers 10 on a floor constructed over the underlying soil, placing a piece of plastic or other isolating layer between the soil and the container, or elevating the containers. The preferred method that is shown in the drawing figures is to elevate the containers 10 on stands 14. This not only isolates the containers 10 from the soil, but also promotes better drainage.

By isolating the containers 10 from direct contact with the ground, contamination from soil-borne organisms such as nematodes, pathogens, weeds, etc. is greatly reduced, which also greatly reduces the need to apply insecticides and herbicides.

Periodic root-trimming is also usually necessary for good plant health and development. Roots that are allowed to overdevelop within the containers 10 may block the drainage openings 12. Root trimming also encourages faster development of the plant and increased absorption of fertilizer, moisture and nutrients provided within the containers. The periodic removal of some root mass creates an imbalance in the root/shoot ratio for the plant, which triggers a hormone release that invigorates plant growth. However, the growing of the plants in a confined space such as the containers 10 creates a root-bound condition that leads to the dwarfing of the plants. This stunting of the plants physical growth produces a plant that reaches reproductive maturity earlier. Thus, for fruit and nut bearing plants, production of fruit and nuts occurs earlier, and the plant is of a size that does not require ladders or other means for harvesting the fruit and nuts.

The growing of plants in the containers 10 also provides other advantages. The containers 10 and growing medium therein, being above-ground, are more quickly warmed by the surrounding environment, which provides for an extended and improved growing season. For example with citrus trees, new growth associated with flushing typically begins in mid February. The warmer growing medium in the container 10 promotes higher levels of new growth at this time of the year. By early March this new growth starts putting out flowers, which also favors the warmer growing medium. The drainage of the growing medium from the containers 10 also provides a drier environment. The overall effect is that the warmer, drier growing medium produces a better flush, which in turn leads to better flowering and eventual fruit production.

The drier growing medium also leads to more efficient oxygenation of the soil, and increased oxygen transfer to the roots of the plants, enhancing plant growth throughout the year.

A warmer and drier growing medium in the spring also leads to enhanced fruit quality, especially in citrus. A warmer and drier growing medium promotes citrus fruit with increased sugar levels and decreased acids, which together result in improved fruit quality.

The containers also prevent damage from animals such as gophers and ground squirrels that can damage the roots of plants that are planted in the ground.

As previously mentioned, and will be discussed further, the containers 10 allow also for a more efficient application of water and nutrients to the root zone within the container 10. With a confined irrigation system, such as a drip, micro-spray, capillary or wet-bed irrigation systems, the water and nutrients contained therein may be supplied to the container in controlled applications as continually needed for maximized plant growth, development, and production.

The additional benefits of the development of confined feeder root systems will become more apparent in later discussions of the present invention. Cultivation using the typical berms and flood irrigation results in unconfined and expanded feeder root development which is susceptible to nematode infestation and does not enjoy the many benefits that result from the methods and components of the present invention.

As is obvious to a person skilled in the art, this technique may also be used with single plants planted individually instead of in a row as used in commercial production as shown in the figures.

Another component of the present invention is the use of confined irrigation and fertigation. The depicted embodiment of the confined irrigation and fertigation system comprises the use of standard industry plastic feeder conduit 20 that lies over the containers 10 along a row of plants. However, the feeder conduit 20 may be any kind of liquid delivery conduit such as pipes, tubes or hoses made from a variety of materials.

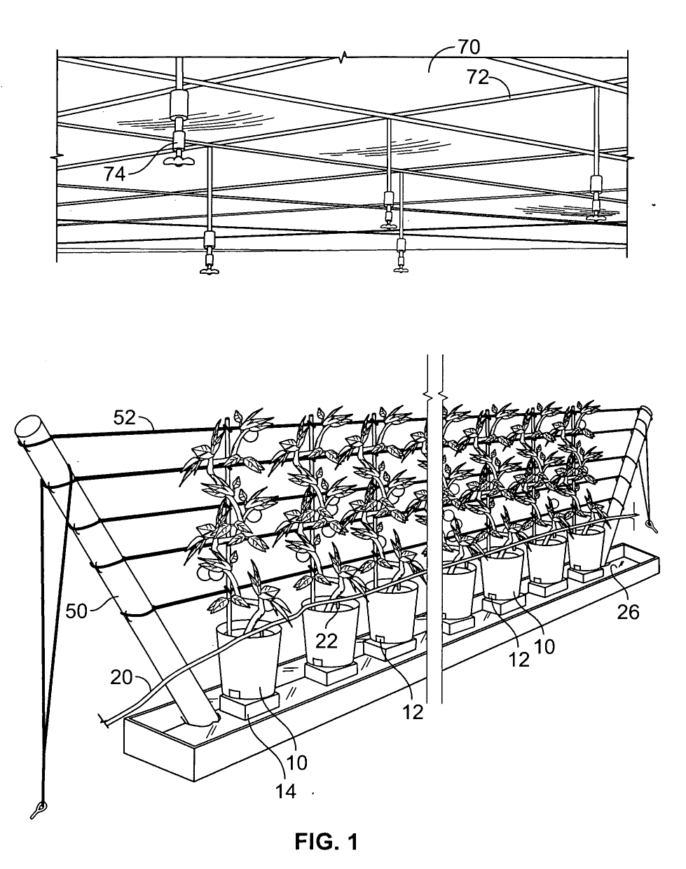

As shown in FIG. 1, a drip system includes emitters 22 disposed along the conduit 20 through which liquid may be dispensed. Preferably a drip emitter 22 is located at the base of a plant and a drip emitter 22 is located to each side of the plant. For example, for use with fruit trees, an emitter 22 would be placed at the base of the tree and to either side of the container. Alternately, several emitters 22 may surround the plant at various spaced apart locations over the container 10. The emitter 22 may simply be a small hole or a drip emitter in the conduit 20 through which liquid may slowly escape. The drip emitter 22 may also be a small tube running from the conduit 22, and into the container 10.

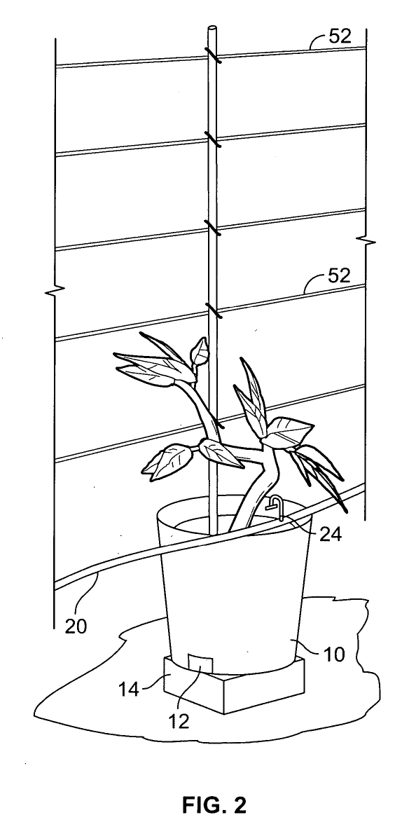

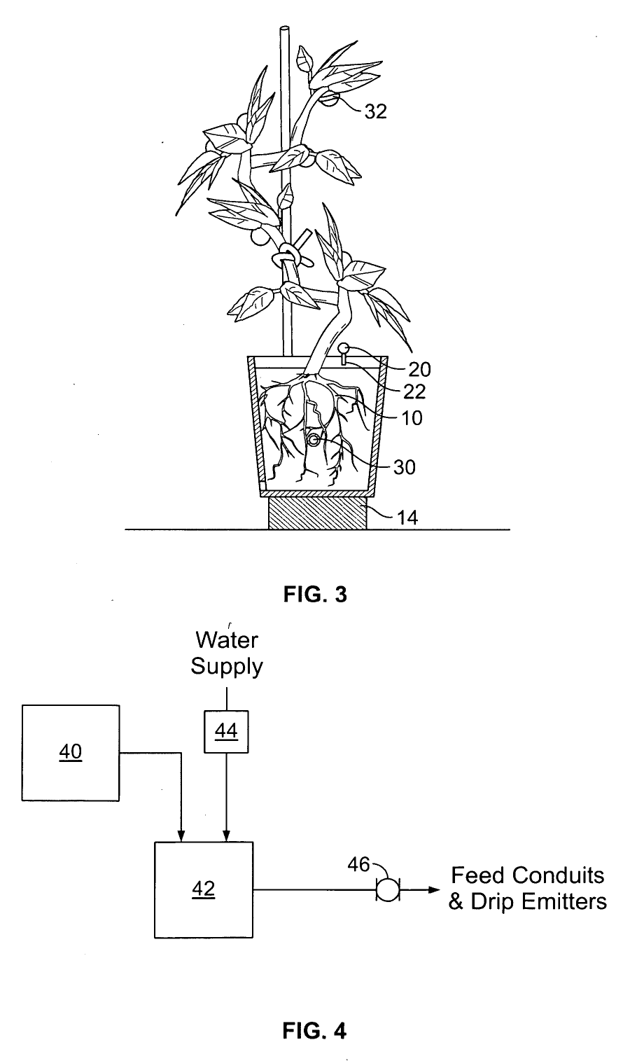

Alternatively, the confined irrigation and fertigation system may include micro-spray emitters 24, as shown in FIG. 2. The micro-spray emitters 24 confine the amount of sprayed liquid to only the area within each container 10, to limit waste and the amount of irrigation that is needed for the plants.

For plants that require constant moisture or are moisture tolerant, another alternative embodiment (not shown) of the confined irrigation and fertigation system may employ capillary or wet bed irrigation systems in which the containers 10 may be placed in a low walled enclosure in which irrigating water is supplied. The water (with any dissolved fertilizers and nutrients) seep into the containers through the openings 12 in the bottom.

The exact frequency and duration of watering depends on the plant type, the age of the plant, the season of the year, and the evapotranspiration rate. For example, for use with trees, watering may occur every two to three days for up to two hours at a time for a young tree. By the time a tree has reached several years in age watering may occur multiple times in an hour, for up to 10 minutes at a time. The use of field sensors, which will be further discussed later, may be used to determine the amount of watering that is needed.

The specific performance characteristics of the emitters 22, 24, and their exact spacing in the container is not critical to the ultimate distribution of water and fertilizer (discussed in greater detail later) by the confined irrigation and fertigation system. It is the purpose of the confined irrigation and fertigation system to apply water and fertilizer only where and when it is needed, thus reducing the consumption and cost of water and fertilizer. The confined irrigation and fertigation system ensures that water and fertilizer is applied only within the containers 10.

Excess water and fertilizer that drains from the containers 10 may be collected and recycled. As shown in FIG. 1, a shallow channel 26 is provided below the containers 10 in which excess water and fertilizer may collect. This reduces the waste of water and fertilizer, and prevents any contamination of the underlying soil and run-off into surface and ground water supplies.

Another component of the present invention is the use of electronic sensors. The sensors include sub-soil sensors (e.g. tensiometers) 30 and plant sensors 32 located on the plants themselves.

The amount of water that needs to be applied to the plants may be determined by the sub-soil sensors 30 buried within the containers 10. The objective is to maintain well-watered plants, and prevent unnecessary overwatering.

Additional plant sensors 32 may be applied to the fruit, stems and leaves of plants to monitor the physiological changes in the plant and also gauge the amount to water the plants. One of the physiological roles of fruit is as a reservoir for water. Immediately after watering, the fruit swells to its greatest size, but as the plant loses water through transpiration the fruit decreases in size. The plant sensor 32 provides direct feedback on these changes and may be used to determine an optimum watering pattern. Similar plant sensors 32 may also record equivalent responses in stem and leaf changes, as well as temperature changes on leaves. The plant sensors 32 may also take air temperature and humidity readings if desired.

Inputs from the sub-soil water sensors 30 and plant sensors 32 may be used to provide signals to a watering control system (not shown) that determines and automatically executes an optimum watering pattern depending on growing medium and plant condition feedback from the sensors 30, 32.

Fertilizers may also be directly incorporated in the water in the confined irrigation and fertigation system. This is known as the ferigation component of the present invention. In a simple embodiment, feed tank 40 supplies fertilizer and nutrients to a mixing tank 42 in which the fertilizer is mixed with water from a water supply. Water for the fertigation system is first run through a filter 44 to remove the particulates that may clog the drip emitters or spray system. The resulting mixture is provided at a desired concentration through a pump 46, and supplied for distribution to the plants to the feed conduits 20 and emitters 22, 24. A fertigation control unit (not shown) may be used to control the supply of fertilizers and nutrients from various feed tanks to various mixing tanks to provide various solutions of feed formulas. The fertigation control unit, possibly in conjunction with the watering control system, may electronically control flow valves linked by computer to continuous in-line meters that measure the levels of the additives in the water. Thus, the main water feed to the drip irrigation system is provided with the desired levels of fertilizers and nutrients needed by the plants as regulated by the fertigation control unit. The specifics of added fertilizer and nutrients, as well as the frequency and duration of application, are determined by the types of individual cultivare, their age, the time of the year, and plant growth and development stages.

By continually providing the plants with optimal moisture and nutrient levels, plants that typically establish large root systems may be grown hydroponically in confined containers. Contrary to conventional belief, growing plants by such a hydroponic method, although stunting the physical size of the plant, actually allows for faster initial growth of the plant, and increased fruit or nut production in a shorter amount of time. Thus, for such plants, increased fruit or nut yields are produced from smaller, more easily harvested plants, in a confined space, without the expansive root development. This method actually allows for plants to be commercially and economically viably grown in controlled environments anywhere in the world.

A further benefit is that the confined irrigation/fertigation system, by continually providing the optimum nutrients to a plant throughout its life, results in fruits, nuts or other plant material harvested for consumption with increased nutrients. Thus the fruit, nut or other plant material is also of a better quality from a nutritional standpoint.

A drawback to this hydroponic method of growing plants is that the loss of water in the containers 10 through evaporation leads to higher concentrations of nutrients in the growing medium than is optimal, and eventually may create a toxic environment for the plants. It was discovered that flushing (not to be confused with the previously described flushing of flowering plants in the spring) the containers with pure water to remove the excess nutrients was equally adverse to the plants. Flushing with pure water quickly removed excess nutrients from the growing medium, however it also has the negative effect of drawing nutrients from out of the plants. This places a great stress on the plants.

To solve this flushing problem, the flushing treatment uses the same type of solution used in the irrigation and fertigation component, having an optimal amount of fertilizer and nutrients dissolved therein. Flushing with such a solution removes the excess nutrients from the growing medium and maintains the optimal amount of nutrients therein, without stressing the plants. The excess nutrients and solution may be collected in the channel 26, or by any other collection means, and recycled from future use.

The use of each of the above components in the cultivation system of the present invention has resulted in the rapid but stunted growth of various plants. By confining the feeder roots of a plant, the intrinsic root/shoot ratio for each plant forces the plant to limit its growth. This stunts the growth of plant once it reaches a certain size. However, the confined irrigation and fertigation system also provides the optimum amount of moisture and nutrients to the plant, which promotes rapid growth. The result of this combined effort is a plant which quickly grows to a stunted size, at which point the plant is “tricked” into “believing” it has matured. For fruit and nut bearing plants this early maturation is especially beneficial because fruit or nut production also begins early. Furthermore, since the growth of the plant is stunted after a certain point, less of the plant's energy is spent on plant growth, and more is spent on fruit or nut production, which results in increased fruit or nut yields.

A consequence of early fruit or nut production is that the young plants are not yet sufficiently strong enough to bear the weight of a fruit or nut crop. Without artificial support the weight of a fruit or nut crop on a young plant literally tears the branches from the trunk of the plant. In order to overcome this problem a support system may need to be used.

Preferably the support system is a trellis system such as has been used for growing vine crops, such as grapes. The trellis has posts 50 with wires 52 strung between the posts 50 at various heights. The branches of the plants are thus supported by the suspended wires 52, and the trellis supports the weight of the fruit-laden branches instead of the trunk of the plant.

Another advantage of the support system as shown is that the outreaching branches of a plant may be manipulated to grow along the trellis. Thus, for example, the branches of a row of trees may be grown along the trellis to create a hedge. For fruit and nut bearing plants this is especially advantageous in that it provides an increased amount of sunlight along the entire row, and adjacent rows. The combination of the stunted or dwarfed plants in a hedgerow configuration allows greater sunlight to each of the plants, allows for reduced spacing (increased number of plants per given area), and also allows for easier harvesting of a fruit or nut crop.

While the drawing figures depict the present invention as used with young citrus trees, it is understood that many plants, fruit and nut bearing or not, may benefit from this cultivation method and related components. These plants include, but are not limited to, citrus trees, deciduous trees, subtropical trees, bushes, shrubs and vines. The term fruit as used herein also is intended to include berries.

A final component as shown in FIG. 1 is an overcovering structure. An embodiment of the overcovering structure includes netting 70 that is supported above the plants. The netting 70 is supported by cables 72 strung over vertically extending posts (not shown) or some other structure. Misters 74 are also preferably provided and allow a protective spray of water to be used in hot or cold conditions, if necessary.

The netting 70 provides a number of advantages. The netting 70 may be used to partially block the amount of sunlight reaching the plants. In some environments, and for some plants, too much sunlight can stress a plant. Too much sunlight heats the plant, may “sunburn” the plant, and causes excessive transpiration of the plant and soil evaporation, which dehydrates the plant.

The netting 70 also provides a space thereunder which can more easily be manipulated when adverse climatic conditions occur. If overly hot conditions occur, the misters 74 may be used to cool the space under the netting. The misters 74 also increase humidity within the space to a limited extent depending on the porosity of the netting and outside wind conditions. In overly cold conditions the misters 74 similarly may be used to protect against frost or freeze damage. The netting 70 also provides some insulating effect, trapping the heat radiated from the soil or preventing warm outside air from mixing with cooled air inside the structure.

The netting 70 also protects the plants from adverse weather related conditions. Wind, hail and heavy rain can deflower a plant. Wind can also cause damage to the branches and leaves of a plant, and blemishes on fruit caused by wind-driven impacts and abrasion. Wind may also deposit dust on the leaves of the plants. A dust layer reduces the ability of the leaves to absorb solar energy. The netting 70 substantially prevents the formation of a dust layer. The netting 70 may also extend downward to the ground, forming walls, completely enclosing a given area.

The netting 70 also reduces the infestation of pests such as flying insects and birds.

Another overcovering structure that is well known and thus not shown in the drawing figures, and which may be necessary in certain climates, is a greenhouse.

As can be seen from the above description, the method and components of the present application provides substantial benefits. With respect to the plants themselves, the benefits include increased growth rate, early maturation, early and increased yield of fruit, nuts and harvested plant material, easier harvesting, less stress on the plants, increased quality of fruit, nut and plant material, and increased numbers of plants that can be grown in a given area. With respect to economic benefits, there is savings in labor, savings in water, fertilizer, herbicides and pesticides, and increased plant productivity and overall profit. With regard to environmental benefits, water and fertilizer resources are saved, the use of environmentally harmful chemicals is reduced, run-off into water sources is reduced, erosion is reduced, and the amount of land tied up in agriculture is reduced.

While the invention has been described with reference to specific embodiments, it will be apparent that numerous variations, modifications and alternative embodiments of the invention are possible, and accordingly all such variations, modifications and alternative embodiments are to be regarded as being within the scope and spirit of the present invention as claimed.

What is claimed is:

1. A method of hydroponically cultivating plant material comprising the steps of:
providing a container and growing medium for a plant to develop roots, the container being sized to confine the development of the roots thereby stunting the overall physical growth of the plant; and
providing nutrients and moisture into the container to promote the growth of the plant.

2. The method according to claim 1 further comprising the step of providing said plant material from the group consisting of citrus trees, deciduous fruit trees, nut trees, vine crops, subtropical fruit trees, and berry producing bushes and shrubs.

3. The method according to claim 1 further comprising the step of providing plant material that develop large root system when grown under normal unconfined conditions.

4. The method according to claim 1 wherein the step of providing nutrients and water into the container further comprises providing a confined irrigation and fertigation system.

5. The method according to claim 4 further comprising the steps of:
providing an irrigation conduit;
providing a liquid emitter; and
providing water through said conduit at a predetermined schedule, said water providing irrigation to said container through said emitter.

6. The method according to claim 5 wherein said emitter is provided above said container.

7. The method according to claim 1 further comprising the step of providing multiple containers for cultivating plant material in rows.

8. The method according to claim 1 further comprising the step of providing a drainage opening in said container.

9. The method according to claim 1 further comprising the step of isolating the container from direct contact with the underlying soil.

10. The method according to claim 9 wherein said container is isolated from the underlying soil by elevating the container.

11. The method according to claim 10 wherein said container is placed upon a stand.

12. The method according to claim 5 wherein said emitter is a drip emitter.

13. The method according to claim 5 wherein said emitter is a micro-spray emitter.

14. The method according to claim 1 further comprising the step of providing a sub-soil moisture sensor in said container.

15. The method according to claim 14 further comprising the step of providing an automated irrigation system that controls a supply of water through irrigation conduits based upon moisture level inputs from said sub-soil moisture sensor.

16. The method according to claim 1 further comprising the step of providing a plant sensor on the plant to measure physiological changes in the plant.

17. The method according to claim 16 wherein said plant sensor also provides temperature and humidity readings.

18. The method according to claim 12 further comprising the step of providing fertilizer and nutrient additives with the water during irrigation.

19. The method according to claim 18 further comprising an automated fertigation unit that premixes the water and additives according to predetermined ratios.

20. The method according to claim 1 further comprising the step of providing a plant support system.

21. The method according to claim 20 wherein said plant support system is an elevated trellis to which a portion of the plant is affixed.

22. The method according to claim 1 further comprising the step of providing an overcovering structure above the plants.

23. The method according to claim 1 further comprising the step of providing water-spraying misters.

24. The method according to claim 1 further comprising the step of periodically trimming the roots of the plant.

25. The method according to claim 18 further comprising the step of periodically flushing the container with a solution of water and said additives.

26. The method according to claim 1 further comprising the step of providing a means for collecting any run-off from the container.

27. The method according to claim 26 wherein said means for collecting run-off is a channel located below the container.
